(19) United States
(12) Patent Application Publication
(10) Pub. No.: US 2003/0163343 A1
(43) Pub. Date: Aug. 28, 2003

(54) Method and system for dynamically modifying an electronic campaign based on network activity

(75) Inventors: Colin J. Meiser, Irving, TX (US); Cynthia A. O'Shea, Southlake, TX (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation

(21) Appl. No.: 10/085,145

(22) Filed: Feb. 27, 2002

(51) Int. Cl. G06F 17/60

(52) U.S. Cl. 705/1

(57) ABSTRACT

The invention disclosed herein provides a method for eliciting a response to an electronic campaign. The method can include identifying the available network capacity for transmitting electronic content and receiving consumer responses to the transmitted electronic content. The electronic content can be transmitted over the network at a predetermined rate. Concurrently therewith, the effectiveness of transmitting the electronic content can be determined by identifying consumer responses to the transmitted electronic content. The electronic campaign can be dynamically modified according to the determined effectiveness of the electronic campaign and the identified available network capacity.

### BACKGROUND OF THE INVENTION

1. Technical Field

This invention relates to the field of electronic business, and more particularly, to electronic marketing.

2. Description of the Related Art

The pervasiveness of the Internet has allowed companies to engage in electronic commerce with their customers and/or potential customers. The term electronic commerce generally involves conducting business activities such as marketing, purchasing, and the sale of goods and services through one or more computer communications networks (network). Marketing activities conducted over a network generally can be referred to as electronic marketing (e-marketing). Oftentimes, the success of a particular good or service within a given market sector is heavily influenced by the marketing strategies used in promoting that good or service.

Similar to conventional marketing strategies, e-marketing also seeks to increase product and service sales by reaching a significant target audience. Despite the need to reach a large number of potential customers, e-marketing campaigns must not exceed the available bandwidth of the network over which the campaign is conducted. In other words, the network not only must be able to handle normal day-to-day traffic, but also must be able to accommodate increased traffic due to the sending of promotional content as well as the receipt of customer inquiries responsive to the e-marketing campaign.

Presently, conventional e-marketing systems utilize an off-line multi-step process to implement e-marketing campaigns. The process begins by developing an e-marketing campaign and identifying a target audience for the campaign. A quantitative analysis then can be performed to determine the likely amount of network traffic that will be generated by the e-marketing campaign. Another analysis is then performed separately to determine the peak capacity of the network, less any non-marketing related traffic already in existence. If the analysis indicates that the e-marketing campaign will result in a network or system overload condition, then the target audience is limited to prevent such a condition. Alternatively, a different execution strategy for the e-marketing campaign can be developed so as not to exceed the network capacity. In any case, such determinations are made prior to beginning the e-marketing campaign.

As most conventional e-marketing systems rely upon theoretical models which are based on historical and statistical data, realtime network conditions, for example the actual network effects resulting from an ongoing e-marketing campaign, typically are not adequately considered. While the use of historical and statistical data can provide a basis for estimating the effectiveness of an e-marketing campaign and the network congestion resulting therefrom, conditions such as unexpected user demand can render the theoretical models invalid. Thus, network overload conditions still can occur.

### SUMMARY OF THE INVENTION

The invention disclosed herein provides a method and apparatus for dynamically modifying an electronic marketing campaign. More specifically, the present invention can implement an electronic marketing campaign and dynamically modify the electronic marketing campaign according to a monitored target audience response rate and computer communications network (network) congestion resulting from the campaign in light of available network capacity and available bandwidth. For example, outbound electronic marketing content can be provided over one or more delivery channels such as electronic mail, Web site banner advertising, or the like. Inbound responses to the outbound content can be tracked and can be associated with the particular outbound electronic marketing content and delivery channel to which the consumer has responded. In this manner, the effectiveness of the electronic marketing campaign can be determined. Accordingly, the electronic marketing campaign can be modified so as not to overload the network.

The present invention utilizes available network bandwidth more effectively than prior art systems thereby ensuring the delivery of electronic marketing content to those demographics more likely to respond favorably. By regulating the electronic marketing campaign according to factors such as the network capacity and the targeted audience response rate, the electronic marketing content communicated to the target audience can be adjusted earlier and more frequently than in conventional electronic marketing campaigns. Moreover, dynamically adjusting the electronic marketing campaign responsive to ongoing monitoring of the audience response rate limits the possibility of a network outage, traffic congestion, and/or other network associated problems.

One aspect of the present invention can include a method of eliciting a response. The method can include identifying the available capacity of a network for transmitting electronic content and receiving consumer responses to the transmitted electronic content. For example, the available bandwidth of the network can be determined and a bandwidth utilized by the outbound electronic content and the received consumer responses also can be determined.

When the electronic campaign begins, the electronic content can be transmitted over the network at a predetermined rate. Notably, the electronic campaign can be an electronic marketing campaign and the electronic content can be electronic marketing content. The effectiveness of the electronic campaign can be determined concurrently with the implementation of the electronic campaign. For example, as the campaign continues, the consumer responses to the transmitted electronic content can be identified and counted. If the transmitted electronic content is transmitted over a plurality of delivery channels, the received consumer responses can be associated with the particular delivery channel used to transmit the electronic content to which the consumer has responded.

Accordingly, the rate at which the electronic content is transmitted over the network can be dynamically modified according to the determined effectiveness of the electronic campaign and the available capacity of the network. Still, the rate at which the electronic content is transmitted can be dynamically increased over at least one delivery channel associated with at least a predetermined minimum percentage of consumer responses. Similarly, the rate at which the electronic content is transmitted can be dynamically decreased over at least one delivery channel which is not associated with at least a predetermined minimum percentage of consumer responses. At least a portion of electronic content can be redirected from one delivery channel to another delivery channel. Additionally, prior to transmitting the electronic content, the electronic content can be selectively format converted.

Within the electronic content, different message can be selected in favor of other messages for transmission. For example, at least one message from the electronic content can be selected wherein the selected message is associated with more consumer responses than other messages of the electronic content. The selected message then can be transmitted in place of the other messages.

Another aspect of the present invention can include a system for dynamically modifying an electronic campaign. The system can include at least one delivery application configured to format electronic content and transmit the electronic content to consumers over a computer communications network. The system further can include a network analysis component configured to determine available network capacity according to, at least in part, the transmitted electronic content and the consumer responses, and to balance the network load according to the determined available network capacity.

A meter configured to determine the effectiveness of transmitting the electronic content also can be included in the system. The meter can determine the effectiveness of the electronic campaign by identifying consumer responses to the transmitted electronic content. The meter further can be configured to dynamically modify the rate at which the electronic content is transmitted over the network according to the determined effectiveness and the available capacity of the network. The system also can include a message controller configured to dynamically increase the transmission rate of electronic content through at least one delivery channel, wherein the selected delivery channel can be associated with at least a predetermined minimum percentage of consumer responses. Prior to transmitting the electronic content, the message controller can selectively format convert the electronic content according to the determined available network capacity.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating an exemplary electronic marketing system in accordance with the inventive arrangements disclosed herein.

FIG. 2 is a flow chart illustrating a method of electronic marketing which can be used with the system of FIG. 1.

### DETAILED DESCRIPTION OF THE INVENTION

The invention provides a method and system for dynamically modifying an electronic marketing (e-marketing) campaign based on network activity. In particular, the present invention can determine the network capacity over which the e-marketing campaign is conducted and also monitor the effectiveness of the e-marketing campaign. Based on the determined network capacity and the effectiveness of the e-marketing campaign, the e-marketing campaign can be dynamically adjusted or regulated. This ensures that available network capacity is more efficiently utilized and that particular demographic segments of a target audience which have responded favorably to the e-marketing campaign can be more effectively targeted.

An e-marketing campaign as used herein can be an advertising campaign performed using a computer communications network. Accordingly, e-marketing content, or advertising, can be provided to consumers using one or more delivery channels. The delivery channels can be public or private channels such as electronic mail, advertising on Web sites whether banner or billboard advertising, advertising that is downloaded to a personal communications device, and the like.

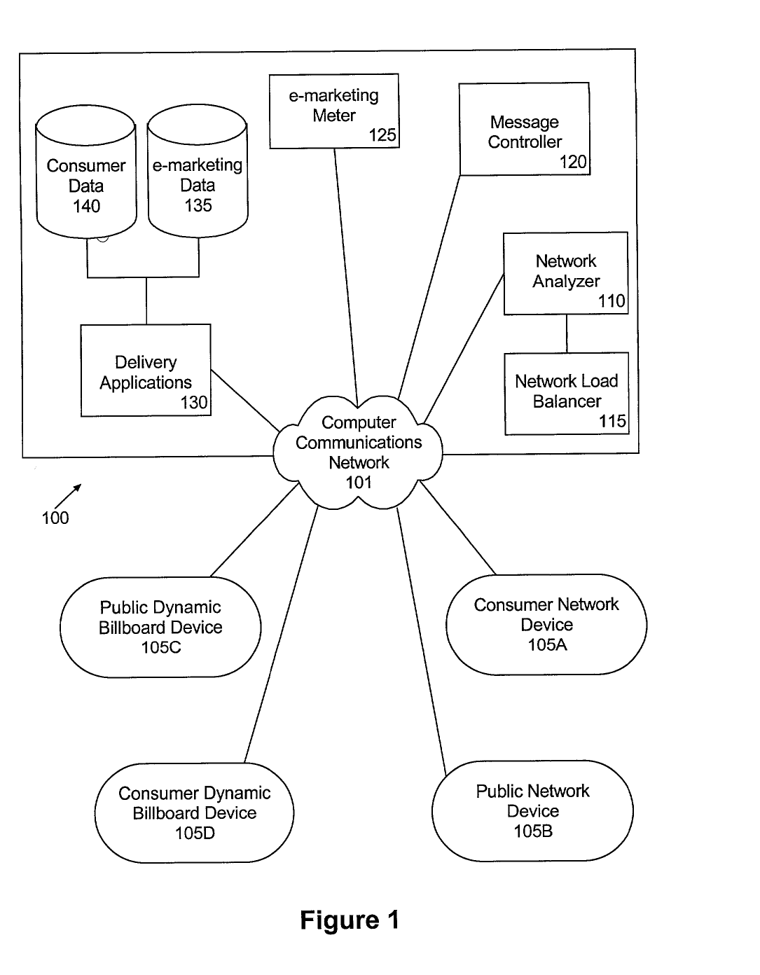

FIG. 1 depicts an exemplary e-marketing system 100 in accordance with the inventive arrangements disclosed herein. Referring to FIG. 1, there is shown a computer communications network (network) 101, connected with a plurality of access devices 105. The system 100 also can include a network analyzer 110, a network load balancer 115, an e-marketing message controller 120, an e-marketing monitor 125, and e-marketing delivery applications 130.

The network 101 can be a packet and/or circuit switched network. The network can include, for example, an area network configured to communicatively link the delivery applications 130, the e-marketing meter 125, the message controller 120, the network analyzer 110, and the network load balancer 115, as well as a larger network such as the Internet and/or the public switched telephone network which can be communicatively linked to the area network. Accordingly, the network 101 can facilitate the transmission of e-marketing content to the access devices 105 as well as the reception of responses from members of a target audience resulting from the delivered e-marketing content.

The access devices 105 can include a consumer network device 105A, a public network device 105B, a public dynamic billboard device 105C, and a consumer dynamic billboard device 105D. For example, consumer network devices 105A can include, but are not limited to, portable computing devices and/or personal digital assistants, computers systems, wireless appliances such as telephones and pagers, and other Internet access devices.

Public network devices 105B can include, but are not limited to Web banner pages or banner advertising. Public network devices 105B further can include any other publically accessible machine that can be communicatively linked to the system 100 for receiving e-marketing content, and optionally, transmitting consumer responses to the e-marketing content to system 100. For example, public network devices 105B can include devices which can incorporate a display or audio interface such as vending machines, telephones, gas pumps, or programmable billboards or marquees. In illustration, while pumping gas, the gas pump can display a message stating that should the consumer take the gas receipt to a participating store, the consumer will receive a discount for selected merchandise at the participating store.

Dynamic billboards, as are known in the art, can include software components that can display a number of images by stepping through the images one at a time, and thus, can be used in both a public context as a public dynamic billboard 105C, for example on a Web site, or in a private context as a private dynamic billboard 105D, for example when provided to a consumer network device 105A.

The e-marketing delivery applications 130 can access e-marketing content including, for example, images, text, audio, and video from the e-marketing data 135. The e-marketing delivery application can access the e-marketing content and provide the content to members of a target audience specified within the consumer data 140. Notably, the consumer data 140 can include contact information for known and potential consumers. The consumer data 140 further can include statistical information regarding each consumer's response to previous e-marketing campaigns as well as any ongoing e-marketing campaigns. In any case, depending upon the e-marketing campaign, the e-marketing content can be provided through private communications such as electronic mails or through public channels such as Web-site advertising in any of a variety of forms. Those skilled in the art will recognize that e-marketing content can be provided through any suitable delivery channel as specified by the e-marketing campaign. For example, e-marketing content can be provided through electronic mails, banner advertising on Web-sites or consumer network devices, as well as billboard advertising on Web-sites and consumer network devices.

The network analyzer 110 can be configured to monitor at least that portion of the network 101, for example an area network, which connects the various components of system 100. Thus, the network analyzer 110 can acquire network statistics regarding the usage and available bandwidth of the network. Network analyzers are well known in the art and can employ protocols such as simple network management protocol (SNMP) and remote monitoring (RMON). The network load balancer 115 can be configured to communicate with the network analyzer 110 and balance the load on the monitored portion of network 101 based on the network statistics acquired by the network analyzer 110.

The e-marketing meter 125 can be configured to monitor the effectiveness of the e-marketing campaign. The e-marketing meter 125 can regulate or control the flow of messages or e-marketing content from the e-marketing delivery applications 130 based upon available network capacity as determined by the network analyzer 110. Additionally, the e-marketing meter 125 can determine the number of response messages being received as a result of the e-marketing campaign. The response rate, in addition to the delivery channels and type of e-marketing content to which the consumer has responded, can be used in determining the number of outbound transmissions of e-marketing content to be sent. Thus, the e-marketing meter 125 can regulate the outbound transmission of e-marketing content according to the network capacity, the amount of outbound message network bandwidth required, and the amount of inbound message network bandwidth required.

The e-marketing message controller 120 can be configured to regulate the formatting of e-marketing content generated by the e-marketing delivery applications 130. For example, the e-marketing message controller 120 can communicate with the e-marketing meter 125 to determine that more consumer responses have been received within an ongoing e-marketing campaign as a result of public Web banner pages than private electronic mails. Accordingly, the e-marketing message controller 120 can instruct the e-marketing delivery applications 130 to redirect selected e-marketing content from private electronic mail to Web banner pages. Thus, system 100 can be used to implement an e-marketing campaign and simultaneously analyze network capacity to determine the effectiveness of the e-marketing campaign. Accordingly, system 100 can facilitate realtime change to the e-marketing campaign by varying the rate or flow of outbound transmissions of e-marketing content. Moreover, system 100 can redirect particular e-marketing content from one delivery channel or network device to another.

The e-marketing message controller 120 further can be configured to vary the bandwidth required for transmission of e-marketing content. In particular, the e-marketing message controller 120 can format convert electronic content representing pictures, video, audio, and other multi-media content, and either increase or decrease the resolution and/or quality of the respective electronic documents. Accordingly, the bandwidth required to transmit the electronic content can be increased or decreased. Thus, for example, under high network traffic conditions, an audio file can be sample rate converted as well as converted from one file format to another to suit the available bandwidth of the system 100.

In another aspect of the present invention, the e-marketing message controller 120 can be configured to select one of several similar or like messages for transmission. For example, system 100 can include several e-marketing messages relating to a particular product such as “Product A is great” and “Product A is good”. The e-marketing message controller can monitor consumer responses to each of the messages and select the more successful message for future transmissions. Thus, if consumer response to the message “Product A is great” is greater than the consumer response to the message “Product A is good”, the e-marketing message controller can select the message “Product A is great” for future transmissions.

In operation, as e-marketing content is delivered by the e-marketing delivery applications 130, the e-marketing meter can monitor responses resulting from the e-marketing campaign. As the e-marketing campaign continues, the network analyzer 110 can determine the network capacity. For example, network analyzer 110 can collect statistics for network 101 and communicate these statistics to the network load balancer 115. The network load balancer 115 can use the statistics to determine the network capacity or bandwidth available for transferring messages or e-marketing content to the targeted audience and transferring responses from the targeted audience back to the e-marketing meter.

The e-marketing monitor 125 can determine the effectiveness of the e-marketing campaign by assessing the responses received from the targeted audience. Additionally, the response rate for a particular access device and delivery channel can be determined. The e-marketing meter 125 can regulate the transmission of e-marketing content from the e-marketing delivery applications 130 according to the determined overall response rate, the response rate from particular access devices or delivery channels, and based upon the network statistics provided by the network analyzer 110 and the network load balancer 115. For example, the available network capacity, the bandwidth currently used for sending messages to the targeted audience, and the bandwidth utilized for responses can be factors assessed by the e-marketing meter 125. Additionally, the e-marketing meter 125 can assess other factors such as the network traffic which is not a result of the e-marketing campaign.

Notably, by coordinating the output of the network load balancer 115 and the network analyzer 110 with the output of the e-marketing meter 125, the e-marketing message controller 120 can dynamically adjust the e-marketing campaign strategy. In particular, using the determined response rate and network availability information, the e-marketing meter 125 can determine an overall rate of transfer. For example, the bandwidth necessary to implement the e-marketing campaign for different types of access devices over different delivery channels can be allocated. The bandwidth can be allocated on a per device and/or delivery channel basis.

In illustration, if the response rate for a particular e-marketing campaign is significant for consumer network devices, but negligible for public network devices, the e-marketing message controller 120 can correspondingly regulate the e-marketing campaign content. Specifically, the e-marketing message controller 120 can instruct the delivery applications 130 to deliver increased e-marketing content to the consumer network devices and reduce the amount e-marketing content delivered to the public network devices. Similarly, if one delivery channel such as direct electronic mail was determined to be more effective than Web banner advertising, increased e-marketing content can be directed to private electronic mail accounts. Taking another example, the e-marketing message controller 120 further can dynamically redirect e-marketing content, for example with wireless devices, based upon location proximity messaging.

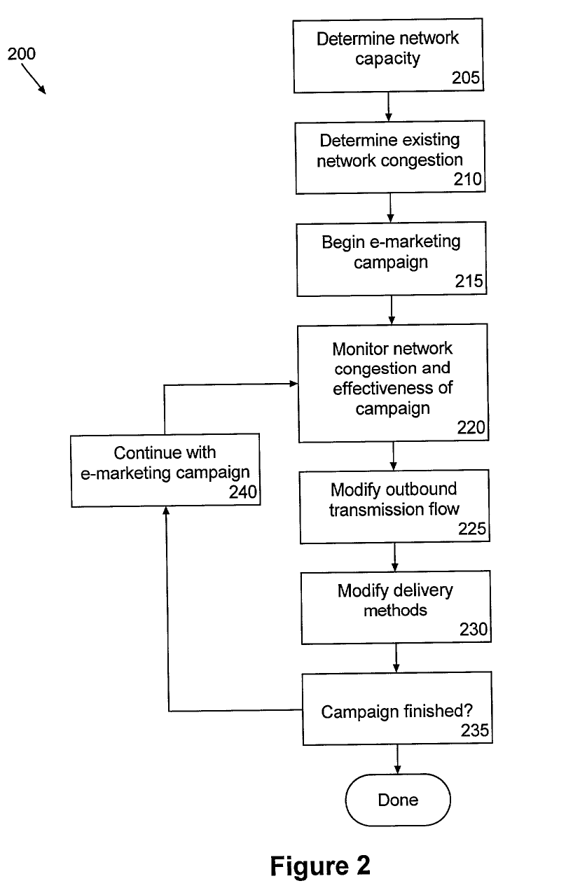

FIG. 2 is a flow chart illustrating a method 200 of electronic marketing which can be used with the system of FIG. 1. The method 200 can begin in a state wherein an electronic marketing campaign has been formulated. For example, the e-marketing campaign can specify particular content to be provided to consumers (consumer devices) as well as the delivery channels over which the content will be provided. The e-marketing campaign further can specify a transmission schedule or rate at which messages are to be sent, for example, a number of messages per hour per channel. In any case, the method 200 can begin in step 205 where the network capacity can be determined.

In step 210, the existing network congestion can be determined. For example, the network traffic can be determined prior to beginning the e-marketing campaign to serve as a reference. Based upon the known reference of existing network traffic, the available network capacity later can be determined as the e-marketing campaign begins. Accordingly, in step 215, the e-marketing campaign can begin.

As the e-marketing campaign continues, in step 220 the network congestion resulting from the e-marketing campaign can be monitored with reference to the available network capacity. Additionally, the effectiveness of the e-marketing campaign can be determined. As mentioned, the effectiveness of the e-marketing campaign can be determined by monitoring the outbound transmissions, whether electronic mails or banner advertising to public or private devices. The consumer responses to the outbound transmissions can be tracked. Notably, the responses can be associated with the particular e-marketing content to which the consumer is responding. Further, the particular channel over which the consumer accessed the e-marketing content can be associated with the consumer response.

In step 225, the outbound transmission flow can be modified as necessary based upon the network congestion and the effectiveness of the e-marketing campaign. For example, if a large number of consumers begin responding to the transmitted e-marketing content, the rate of transmissions can be decreased as the network traffic reaches capacity. Alternatively, if fewer consumers respond and the network traffic is not approaching capacity, the rate of transmissions can be increased. Also, as mentioned, the resolution of the e-marketing content can be modified in accordance with network congestion and the effectiveness of the e-marketing campaign.

In step 230, the channels being utilized for the transmission of e-marketing materials can be altered if necessary. Specifically, based on monitoring step 220, additional e-marketing materials can be provided to consumers through a delivery channel which has been determined to be either the most or more effective than other channels. Thus, if the monitoring step determines that banner advertising is more effective than electronic mail, more resources can be devoted to providing banner advertising. By the same token, the amount of electronic mail transmissions sent to consumer mail accounts can be reduced.

In step 235, if the e-marketing campaign has finished, the method can end. If not, however, the method can continue to step 240 where the e-marketing campaign can continue according to any modifications implemented in steps 225 and 230. The method then can loop to step 220 to continue monitoring the e-marketing campaign and repeat as necessary.

The present invention can make realtime modifications to an e-marketing campaign while the campaign is in progress. By regulating the flow of e-marketing campaign content based on actual network conditions, network overload and congestion can be prevented. Accordingly, the e-marketing campaign can be more precisely targeted and more cost effective.

The invention disclosed herein can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of eliciting a response comprising:
identifying the available network capacity for transmitting electronic content and receiving consumer responses to said transmitted electronic content;
transmitting electronic content over the network according to a predetermined electronic campaign;
concurrently determining the effectiveness of the electronic campaign by identifying consumer responses to said transmitted electronic content; and
dynamically modifying the electronic campaign according to said determined effectiveness of the electronic campaign and said identified available network capacity.

2. The method of claim 1, wherein said electronic content is electronic marketing content which is part of an electronic marketing campaign.

3. The method of claim 1, wherein said dynamically modifying step comprises:
prior to transmitting said electronic content, selectively format converting said electronic content.

4. The method of claim 1, wherein said step of identifying the available network capacity comprises determining available bandwidth of the network, and determining a bandwidth utilized by said outbound electronic content and said received consumer responses.

5. The method of claim 1, wherein said concurrent determining step further comprises determining a number of received consumer responses.

6. The method of claim 1, wherein said transmitted electronic content is transmitted over a plurality of delivery channels and said concurrent determining step further comprises associating received consumer responses with the particular delivery channel used to transmit the electronic content to which the consumer has responded.

7. The method of claim 6, further comprising the step of dynamically increasing the rate at which the electronic content is transmitted over at least one delivery channel associated with at least a predetermined minimum percentage of consumer responses.

8. The method of claim 6, further comprising the step of dynamically decreasing the rate at which the electronic content is transmitted over at least one delivery channel which is not associated with at least a predetermined minimum percentage of consumer responses.

9. The method of claim 6, further comprising:
selectively redirecting at least a portion of the electronic content from one delivery channel to another delivery channel.

10. The method of claim 5, wherein said step of dynamically modifying the electronic campaign further comprises:
selecting at least one message from said electronic content, said selected message being associated with more consumer responses than other messages of said electronic content; and
transmitting said selected message in place of said other messages.

11. A system for eliciting responses comprising:
at least one delivery application for formatting electronic content and transmitting said electronic content to consumers over a computer communications network;
a network analysis component configured to determine available network capacity according to, at least in part, said transmitted electronic content and consumer responses to said transmitted electronic content, and to balance the network load according to said determined available network capacity;
a meter configured to determine the effectiveness of transmitting the electronic content by identifying consumer responses to said transmitted electronic content, and to dynamically modify the rate at which said electronic content is transmitted over the network according to said determined effectiveness and the available network capacity.

12. The system of claim 11, further comprising:
a message controller configured to dynamically increase the transmission rate of electronic content over at least one delivery channel, wherein said delivery channel is associated with at least a predetermined minimum percentage of consumer responses.

13. The system of claim 12, wherein said message controller is configured to selectively format convert said electronic content according to said determined available network capacity prior to transmitting said electronic content.

14. A machine-readable storage having stored thereon, a computer program having a plurality of code sections, said code sections executable by a machine for causing the machine to perform the steps of:
identifying the available network capacity for transmitting electronic content and receiving consumer responses to said transmitted electronic content;
transmitting electronic content over the network according to a predetermined electronic campaign;
concurrently determining the effectiveness of the electronic campaign by identifying consumer responses to said transmitted electronic content; and
dynamically modifying the electronic campaign according to said determined effectiveness of the electronic campaign and said identified available network capacity.

15. The machine-readable storage of claim 14, wherein said electronic content is electronic marketing content which is part of an electronic marketing campaign.

16. The machine-readable storage of claim 14, wherein said dynamically modifying step comprises:
prior to transmitting said electronic content, selectively format converting said electronic content.

17. The machine-readable storage of claim 14, wherein said step of identifying the available network capacity comprises determining available bandwidth of the network, and determining a bandwidth utilized by said outbound electronic content and said received consumer responses.

18. The machine-readable storage of claim 14, wherein said concurrent determining step further comprises determining a number of received consumer responses.

19. The machine-readable storage of claim 14, wherein said transmitted electronic content is transmitted over a plurality of delivery channels and said concurrent determining step further comprises associating received consumer responses with the particular delivery channel used to transmit the electronic content to which the consumer has responded.

20. The machine-readable storage of claim 19, further comprising the step of dynamically increasing the rate at which the electronic content is transmitted over at least one delivery channel associated with at least a predetermined minimum percentage of consumer responses.

21. The machine-readable storage of claim 19, further comprising the step of dynamically decreasing the rate at which the electronic content is transmitted over at least one delivery channel which is not associated with at least a predetermined minimum percentage of consumer responses.

22. The machine-readable storage of claim 19, further comprising:
selectively redirecting at least a portion of the electronic content from one delivery channel to another delivery channel.

23. The machine-readable storage of claim 18, wherein said step of dynamically modifying the electronic campaign further comprises:
selecting at least one message from said electronic content, said selected message being associated with more consumer responses than other messages of said electronic content; and
transmitting said selected message in place of said other messages.
